(19) United States
(12) Patent Application Publication
(10) Pub. No.: US 2022/0000067 A1
(43) Pub. Date: Jan. 6, 2022

(54) TRAY FOR FEEDING MULTIPLE PETS TOGETHER

(71) Applicant: Robert Leon Sapp, JR., Dallas, GA (US)

(72) Inventor: Robert Leon Sapp, JR., Dallas, GA (US)

(21) Appl. No.: 17/481,060

(22) Filed: Sep. 21, 2021

Related U.S. Application Data
(60) Provisional application No. 63/133,028, filed on Dec. 31, 2020.

(51) Int. Cl. A01K 5/01

(52) U.S. Cl. CPC A01K 5/0114

(57) ABSTRACT

A pet feeder tray having an elevated platform. The platform having multiple apertures for removable receiving bowls. The pet feeder tray having four legs at corners for elevating the platform to the desired height. Bowls adapted to receive the feed of a pet can be removably received within the apertures.

### FIELD OF THE INVENTION

The present invention relates to a pet bowl, and more particularly, the present invention relates to a tray with multiple bowls for feeding multiple pets together.

### BACKGROUND

Dogs can give birth to more than three puppies at a single time. The owner of the pet generally has multiple arrangements to feed several puppies, cats or kittens at one time. A single bowl may not be enough for two or more puppies, cats or kittens to feed together. Thus, a long-term desire is there for a feeding bowl for multiple puppies, cats or kittens.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a pet feeder tray that can be used for feeding several puppies, cats or kittens together.

It is another object of the present invention that the pet feeder tray can be easily assembled and disassembled for storage and transport.

It is still another object of the present invention that the pet feeder tray has rightly sized bowls for puppies, cats or kittens.

It is yet another object of the present invention that the pet feeder tray can be adjusted in height.

It is a further object of the present invention that the pet feeder tray reduces food aggression in puppies.

It is still a further object of the present invention that the pet feeder tray promotes eating in a communal and social setting.

It is an additional object of the present invention that the pet feeder tray reduces gas and other unfriendly symptoms of an unhealthy eating environment for a dog.

It is still an additional object of the present invention that the pet feeder tray aids in having a proper posture of the body while eating.

It is an object of the present invention that the pet feeder tray is economical to manufacture.

It is still an object of the present invention that the pet feeder tray is easy to clean.

In one aspect, disclosed is a pet feeder tray having an elevated platform. The platform having multiple apertures for removably receiving the bowls. The pet feeder tray having four legs at corners for elevating the platform to the desired height. The legs can be coupled to the platform using a hinge joint permitting folding and unfolding of the legs.

In one aspect, the legs of the pet feeder tray can be provided in more than two sizes. The legs can be replaced with legs of a different height without any specialized tools or skills.

In one aspect, each bowl having a rim supported on the tray. The opening in the dray having a dimple that allows lifting the bowl in the aperture.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is an outline view of the pet feeder tray for feeding several puppies together, according to an exemplary embodiment of the present invention.

FIG. 2 shows the pet feeder tray without the bowls, according to an exemplary embodiment of the present invention.

FIG. 3 is a perspective view of a pet feeder tray, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a pet feeder tray that can be used to feed several pets, and in particular, puppies, cats or kittens together. Each puppy, cat or kitten can now have an individual eating place without a blinder to help promote eating in a communal and social setting reducing food aggression in puppies that can transfer in later stages of the dog's life and become more violent to both other dogs and humans. The disclosed feeder can have an elevated height, which can be varied based on the age of the puppies. The elevated pet feeder tray can help to ensure that the dogs eat healthy food from right-sized elevated feeders which is supportive of the dog's health and supports healthy digestion. Healthy eating environments from rightly elevated feeder help to reduce gas and other unfriendly symptoms of an unhealthy eating environment for a dog. Elevated pet feeder tray aids to the posture of dogs eating from the tray. Moreover, the disclosed pet feeder tray supports a litter of pups or kittens equal to number of bowls in the feeder. The disclosed pet feeder tray may also help slow puppies eating pace down to prevent the later need of slow feeders as adult dogs. The height of the disclosed pet feeder tray helps prevent Pups from playing in bowls or moving the bowls.

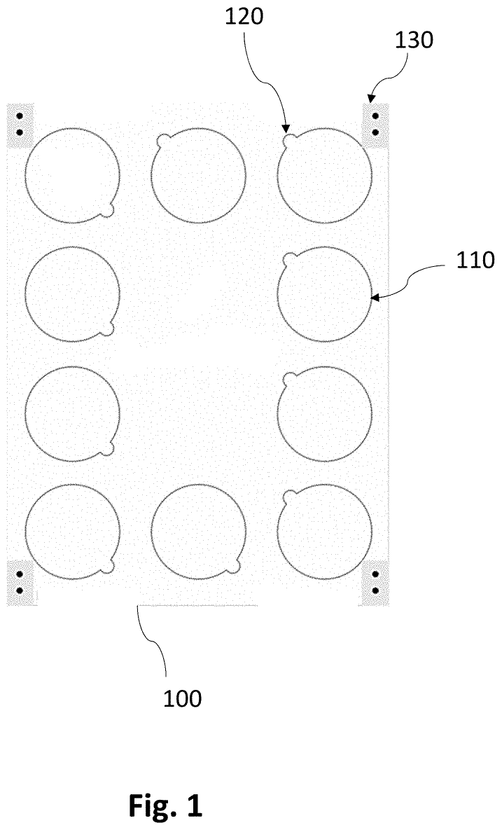

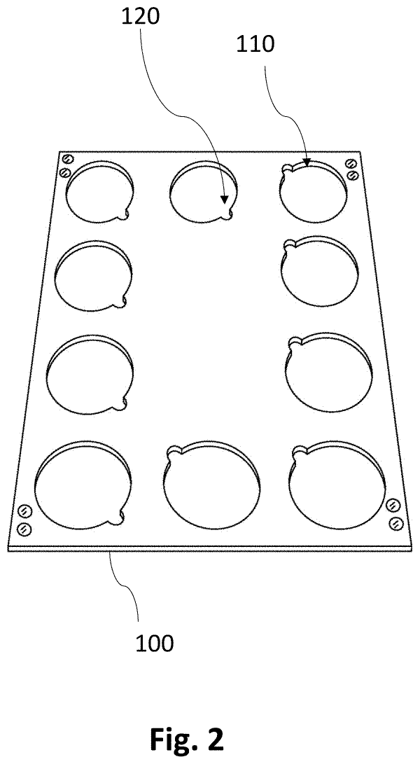

The disclosed pet feeder tray can include a platform having several apertures and bowls received within the apertures. The platform is shown in FIG. 1 and FIG. 2 which is of an elongated rectangular shape. FIG. 1 shows a top view while FIG. 2 shows a perspective view of the platform 100. The platform having two rows of apertures 110 with two additional apertures in the middle. Each aperture can be dimensioned to receive a bowl, wherein the rim of the bowl is retained on the periphery of the aperture. The aperture having a dimple 120 carved on its periphery. It is to be understood that FIG. 1 shows a rectangular shape of the platform, however, the shape can be varied without departing from the scope of the present invention. For example, a round shape platform can be provided. The number of apertures in the platform can also be varied. Preferably, the number of apertures can range from 4 to 14 that can accommodate 4 to 14 bowls.

At corners of the underside of the platform can be coupled legs that allow elevating the platform to the desired height. The legs can be removably coupled to the platform, for example using two or more screws. Typically, the legs of more than one size can be provided which can be replaced with legs of another size. Legs of suitable size can be used in the platform. The legs can be replaced by longer legs when the puppies grow in height. The legs can be coupled to the platform using fasteners 130, such as screws. FIG. 1 shows two screws that can be used to secure one leg to the platform.

In one exemplary embodiment, the legs can be telescoping in nature that allows varying the length of the legs within a predetermined range. The length can be varied in intervals till the telescoping legs are fully extended. To further increase the height of the platform above the ground, the telescoping legs can be replaced with another set of longer legs. The legs can be secured using a hinge joint that allows the legs to be folded and unfolded. For example, the legs can be folded for storage and transportation. Alternatively, the disclosed pet feeder tray can be dismantled with the legs removed for storage and transportation. In one preferred embodiment, the pet feeder tray comes with two sets of legs that grow with the puppies. The first set of legs are shorter for newly weened puppies and the second set of legs are taller to support the rapid rate of growth for puppies.

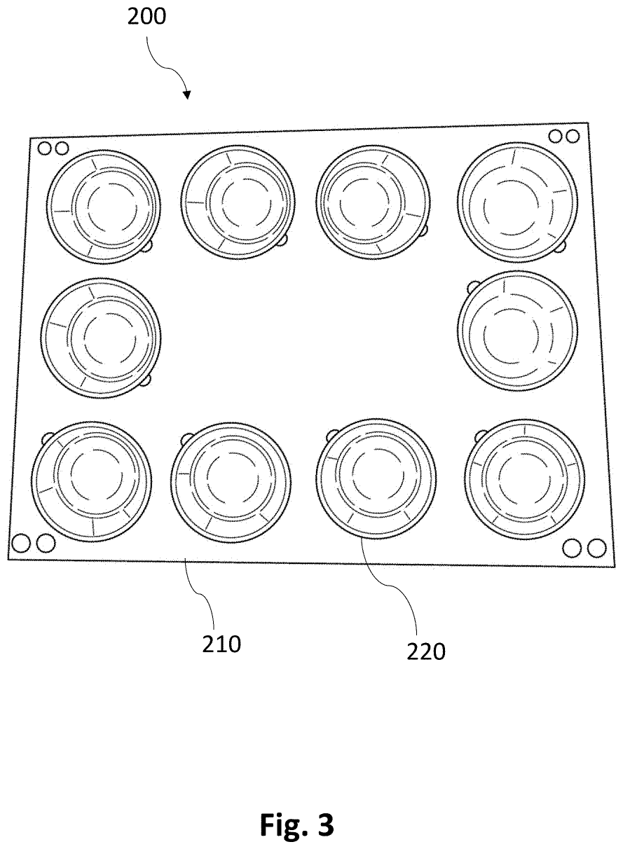

Referring to FIG. 3 showing the disclosed pet feeder tray 200. The pet feeder tray having platform 210 and bowls 220 within the apertures of the platform. The bowls can of a capacity suitable for the feed of a pet. In one case, the bowls can be provided in a capacity ranging from 1 pint to 2 qt or larger. The bowls can be made of metal or plastic. For example, stainless steel or PVC can be used. The bowls shown in FIG. 3 are round, however, the bowls can elliptical, oval, or like shapes.

The bowls are not fixed on the platform and can be removed for cleaning, storing, and filling for the next meal. The platform can also be cleaned after removing the bowls. The platform can be inverted to drop down the bowls from the platform. Alternatively, one bowl can also be removed from the platform. An object can be inserted through the dimple to pick up the bowl from the platform.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A pet feeder tray comprising:
a platform having a plurality of apertures for receiving a plurality of bowls;
the plurality of bowls of a capacity to contain a feed for a pet, each bowl of the plurality of bowls having a rim to support the bowl on the platform; and
a plurality of legs removably coupled to an underside of the platform for supporting the platform at a predetermined height.

2. The pet feeder tray according to claim 1, wherein the platform is having four to fourteen apertures for receiving four to fourteen bowls.

3. The pet feeder tray according to claim 1, wherein the platform is having a dimple cutout in the periphery of the aperture, the dimple permits an object to be inserted for picking up a bowl within the aperture.

4. The pet feeder tray according to claim 1, wherein the platform is rectangular having four legs at its four corners.

5. The pet feeder according to claim 4, wherein the platform is having 10 apertures for receiving 10 bowls.

6. The pet feeder tray according to claim 1, wherein the plurality of legs is coupled to the platform through hinge joints permitting each leg to be folded and unfolded.

7. The pet feeder tray according to claim 1, wherein the plurality of legs is having telescoping tubes allowing the length of each leg to be varied in intervals.

8. The pet feeder tray according to claim 1, wherein the bowls are made of polyvinyl chloride plastic.
